(19) United States
(12) Patent Application Publication
(10) Pub. No.: US 2007/0223870 A1
(43) Pub. Date: Sep. 27, 2007

(54) Single board digital video system

(75) Inventors: Duane J. Farling, Lakeville, MN (US); Peter A. Brew, Minneapolis, MN (US)

Correspondence Address: SHUMAKER & SIEFFERT, P. A., 1625 RADIO DRIVE, SUITE 300, WOODBURY, MN, 55125, US

(73) Assignee: Seagate Technology LLC, Scotts Valley, CA (US)

(21) Appl. No.: 11/387,826

(22) Filed: Mar. 23, 2006

(51) Int. Cl. H04N 5/91

(52) U.S. Cl. 386/46

(57) ABSTRACT

A digital video system integrates onto a single circuit board the features of a hard disk drive with DVR control functionality. The video system includes a front end module that receives and tunes incoming video signals, a DVR module that provides overall system control and DVR trick play functionality and a storage control module that controls storage and retrieval of video content to a mass storage device such as a hard disk drive. In one embodiment, the front end module, the DVR module and storage control module are integrated on a single printed circuit board.

### TECHNICAL FIELD

This application relates to digital video recorders, and more particularly to a single board digital video system that integrates the features of a hard disk drive with DVR control functionality.

### BACKGROUND

The advent of the digital video recorder (DVR) and its ability to digitally store video signals has changed the way viewers record and watch television programs. DVRs provide viewers with much more than the VCR-like ability to “time-shift” their television viewing by recording television programs and viewing them at a later time. Namely, DVRs provide unprecedented control over recording and playback. For example, DVRs allow for “trick modes” such as pausing and slow-motion of live TV, instant replay of interesting scenes, and the ability to skip commercials. Because programs are stored digitally, there is no need to wait for a program to finish recording before watching it. DVRs therefore allow viewers to watch a recorded program even as it is being recorded, or to simultaneously watch one recorded program while recording another. In addition, services such as TiVO® and ReplayTV® provide search tools that help viewers find the programs they want to record. For example, viewers may search programming and other video content by title, actor, director, type or keyword. Services such as these also allow users to set up “wish lists” or “season passes” to automatically find and record desired programming or other video content. DVRs may also include other functions such as recording onto DVDs, sharing of recordings over the Internet, and programming and remote control facilities using PDAs, networked PCs or web browsers.

FIGS. 1A and 1B are top and side views illustrating a typical configuration of components and circuit boards of a conventional DVR 1. A conventional DVR 1 includes at least two circuit boards. Circuit board 2 contains a DVR controller 8A that provides DVR control functionality, tuner/demodulation hardware 8G and 8H that tune incoming television signals to the desired program, and other associated control electronics. A second circuit board, circuit board 3 (removed in FIG. 1A for clarity but shown in side view in FIG. 1B) is associated with an off-the-shelf hard disk drive (HDD) 5 that stores the desired programming in digital form.

Circuit board 3 is mounted on circuit board 2 via mounting brackets 9. Circuit board 3 contains a hard disk drive controller and associated electronics (not shown) that control operation of the HDD 5. Circuit board 3 further includes its own power supply (also not shown) that receives 12V and 5V power and provides bias voltages of −5 V and +3.3 V, as well as power signals of 2.5 V, 1.8 V, 5 V, and 3.3 V. Circuit board 3 distributes power to HDA 7 (discussed below) and to the associated electronic components of HDD 5.

A hard drive assembly (HDA) 7, also mounted to circuit board 3, includes magnetic data storage media (disks), servo motors, read/write heads, etc. that accomplish the physical storage and retrieval of the desired programming. HDA 7 is typically enclosed within a sealed housing.

The separate components of conventional DVR 1, including the DVR controller 8A, HDD 5 and tuner/demodulators 8G and 8H are designed and manufactured utilizing currently available, standardized, off-the-shelf parts. HDD 5, for example, is purchased from a hard disk drive manufacturer or supplier.

In addition to the separate, standardized, off-the shelf hard disk drive, DVR controller 8A and tuner/demodulation hardware 8G, 8H, a typical DVR includes other off-the-shelf components such as video signal inputs 4A, 4B. A flash 8C and a memory 8B are associated with the DVR controller 8A. A/V and modem connectors 4C are spaced along the back side of DVR 1.

Circuit board 2 also includes its own power supply and associated control electronics 8D. Like the power supply on circuit board 3, power supply 8D receives 12 V and 5 V external power generates and distributes the necessary power signals required by the different components of circuit board 3, such bias voltages of −5 V and +3.3 V, as well as power signals of 2.5 V, 1.8 V, 5 V, and 3.3 V.

A data connector 6 located on circuit board 2 and a complementary data connector 3A located on the circuit board 3 provide for communication between the two circuit boards 2 and 3. The data connectors 3A and 6 may include any of several standardized hardware and/or software interfaces, such as PATA (Parallel Advanced Technology Attachment), SATA (Serial Advanced Technology Attachment), SCSI (Small Computer System Interface) and the like. Various standards in the PC industry (to which off-the-shelf hard disk drives are designed) require that the PATA/SATA cable (not shown) over which the circuit boards 2 and 3 communicate be of a minimum length of 18 inches.

Various shielding methodologies are implemented in a conventional DVR to shield the DVR and HDD components and the outside environment from electromagnetic interference (EMI) and electrostatic discharge (ESD) particularly that produced by the PATA/SATA ribbon cable connecting circuit boards 2 and 3, which is a notorious producer of large amounts of EMI and ESD.

### SUMMARY

In general, the invention provides a digital video system that integrates the features of a hard disk drive with DVR control functionality. In one embodiment, the invention is directed to a digital video system comprising a front end module that extracts selected video content from incoming video signals, a digital video recorder (DVR) module that controls storage, retrieval and display of the selected video content, and a storage control module that manages the storage and retrieval of the selected video content to and from a mass storage device under control of the DVR module, wherein the DVR module and the hard disk module are integrated onto a single printed circuit board. The mass storage device may comprise a magnetic hard disk drive.

The details of one or more embodiments of the invention are set forth in the accompanying drawings and the description below. Other features, objects and advantages of the invention will be apparent from the description and drawings, and from the claims.

### BRIEF DESCRIPTION OF THE DRAWINGS

FIGS. 1A and 1B are top and side views, respectively, illustrating a typical physical circuit board and component configuration of a conventional, prior art digital video recorder (DVR).

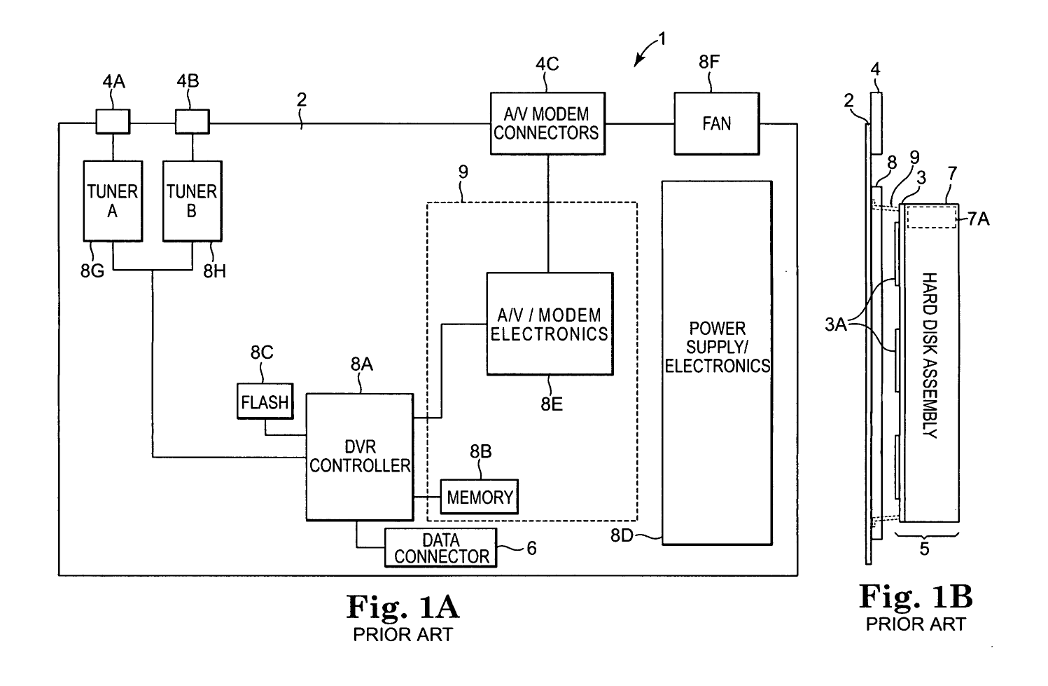

FIGS. 2A, 2B and 2C are top, side, and bottom side views, respectively, illustrating an example physical embodiment of the single board digital video system of the present invention.

FIG. 3 is a block diagram illustrating an example embodiment of the single board digital video system of the present invention.

FIG. 4 is a block diagram illustrating an example embodiment of a front end module shown for terrestrial digital broadcast reception.

FIG. 5 is a block diagram illustrating another example embodiment of a front end module for satellite digital broadcast reception.

FIG. 6 is a block diagram illustrating another example embodiment of a front end module for cable analog and digital broadcast reception.

FIG. 7 is a block diagram illustrating another example embodiment of a front end module for video content reception over the internet.

FIG. 8 is a block diagram illustrating an example embodiment of the DVR module shown in FIG. 3.

FIG. 9 is a block diagram illustrating an example embodiment of the hard disk module shown in FIG. 3.

FIG. 10 is a top plan view illustrating an example embodiment of a magnetic hard drive assembly (HDA).

### DETAILED DESCRIPTION

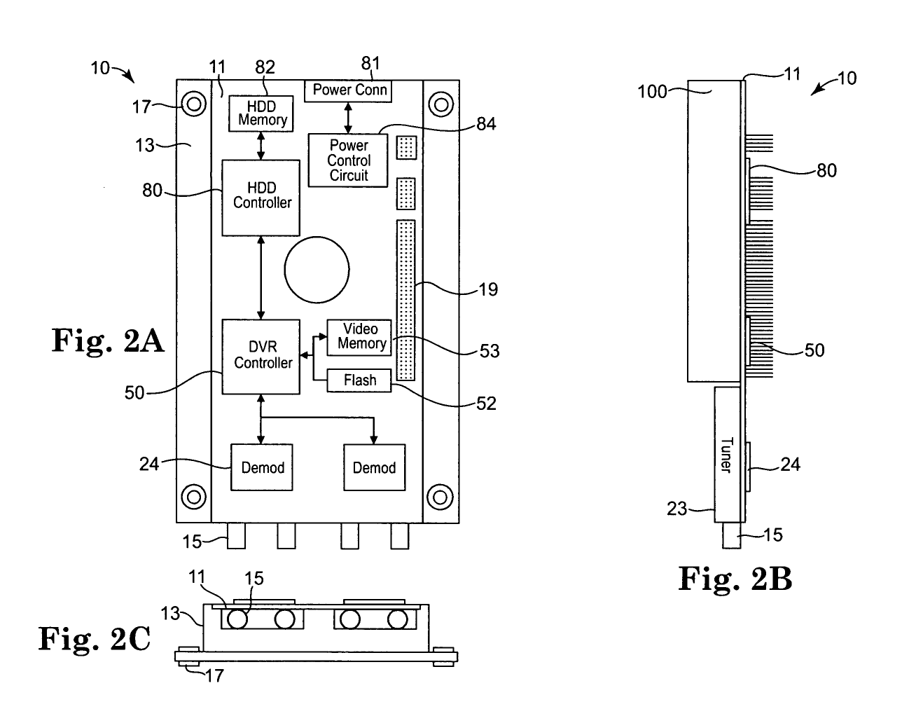

In general, the invention provides a single board digital video system that integrates onto a single circuit board the features of a hard disk drive with DVR control functionality. FIGS. 2A, 2B, and 2C are top, front, and side views, respectively, illustrating an example embodiment of the single board digital video system (hereinafter referred to as “video system 10”). FIGS. 2A-2C illustrate an example physical layout of component parts of video system 10 of the present invention on a single printed circuit board (PCB) 11 as well as physical data storage 100 (in this case a hard drive assembly or “HDA”). HDA 100 is mounted to circuit board 11 via a mounting bracket 13 and several screws 17. External connectors 15 are external connection to tuners 23. Rubber grommets (not shown) between the mounting screws and mounting brackets provide shock and vibration absorption for video system 10.

Video system 10 includes a hard disk drive (HDD) controller 80 and associated HDD memory 82, and power control circuit 84. A power connector 81 allows for connection to an external power source. A DVR controller 50 provides DVR control functionality and has an associated video memory 53 and flash memory 52. Tuners 23 provide for tuning of the incoming video signal and demodulators 24 separate the lower frequency digital content from the higher frequency carrier. Audio/video connectors 19 allow for input/output of various audio/video signals, such as composite video, s-video, component video, left/right audio or other audio/video signals. Physical data storage 100, in this case a hard disk assembly (HDA) 100, is mounted on the underside of circuit board 11.

Although a particular circuit board layout for video system 10 is shown and described with respect to FIGS. 2A-2C, it shall be understood that other circuit board layouts could also be used without departing from the scope of the present invention. The various circuit board components could be arranged on circuit board 11 in a variety of ways, and different components could be mounted either on top side or the bottom side of circuit board 11 depending upon the particular layout chosen by the designer. The example layout shown in FIGS. 2A-2C is merely for purposes of illustrating one particular embodiment in which the video system 10 with integrated physical data storage may be physically fabricated, and the invention is not limited in this respect.

As shown in FIGS. 2A-2C, video system 10 is fabricated such that the electronic components of video system 10 are integrated onto a single circuit board 11. The physical connection for the interface over which DVR controller 50 and HDD controller 80 communicate is, therefore, composed of a circuit board trace. Fabrication of video system 10 using a single circuit board for all of the electronic components provides several advantages over conventional DVRs in which separately fabricated and individual circuit boards, each containing some fraction of the DVR components, are connected using various external connectors such as PATA or SATA ribbon cables and the like.

For example, all of the components for the video system 10 are incorporated into a single circuit board, reducing the number and complexity of components needed to implement the video system and, as a result, the total cost of the video system. Reducing the number of components also improves the overall reliability of the video system. Further, the compact architecture results in a smaller overall size and thickness of the resulting video system. Integrating the DVR module and the HDD module into a single circuit board also reduces the need for communication between different circuit boards and delays associated with such inter-board communication. To phrase another way, video system 10 provides for communication of information between the DVR module and the storage control module without forwarding the information between multiple circuit boards.

As another example, placement of the electronics associated with both the DVR controller 50 and the hard disk drive controller 80 on a single circuit board 11 allows video system 10 to take advantage of ground plane layer(s) located within the circuit board. The purpose of these ground plane layer(s) is to reduce grounding resistance and inductance as well as to provide a shield against EMI and RFI. Using a ground plane to connect all ground points on circuit board 11 helps to ensure that all circuit ground points are at the same potential. A ground plane also reduces the effect of radiated EMI on the performance of a circuit by reducing the electrical field strength in the vicinity of the ground plane. In this way, electrical noise, together with EMI and electrostatic discharge (ESD) performance, can be significantly improved by the use of a ground plane. This may significantly reduce or even eliminate the necessity of additional external shielding. In addition, the physical layout of the circuit board on which video system 10 is manufactured may be designed such that the circuit board traces are as short as possible, which further aids in minimizing EMI radiation.

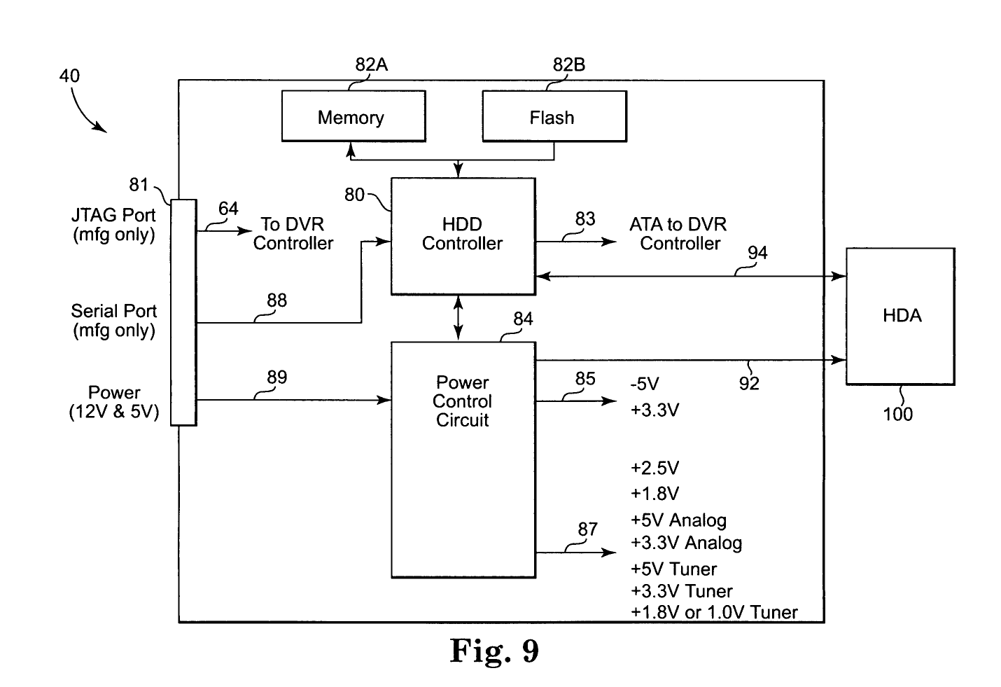

Integration of video system 10 on a single circuit board also allows the various components to share power supplies, memory buffers and other hardware components and eliminates unnecessary interconnects. For example, the various voltages supplied by voltage regulator 86 on storage control module 40 (see FIG. 9) may be shared among the various system components. A power control circuit 84 generates, monitors and controls the power supplied to all of the components of video system 10, including the DVR controller 50, the HDD controller 80, tuners 23 and HDA 100. Thus, fabrication of video system 10 on a single circuit board reduces redundant repetition of certain circuit board components leading to an associated reduction in size, cost and complexity of the resulting video system 10.

As a result, video system 10 is a complete, tested hardware and software solution that integrates the features of a hard disk drive with DVR control and video content reception functionality. By having the necessary hardware and software interfaces, it allows quick design and manufacture of customized DVR solutions that meet local geographic and market requirements. This may be of great advantage to DVR manufacturers, who would no longer need to go through the lengthy and costly design process required to combine the individual components into a workable DVR system.

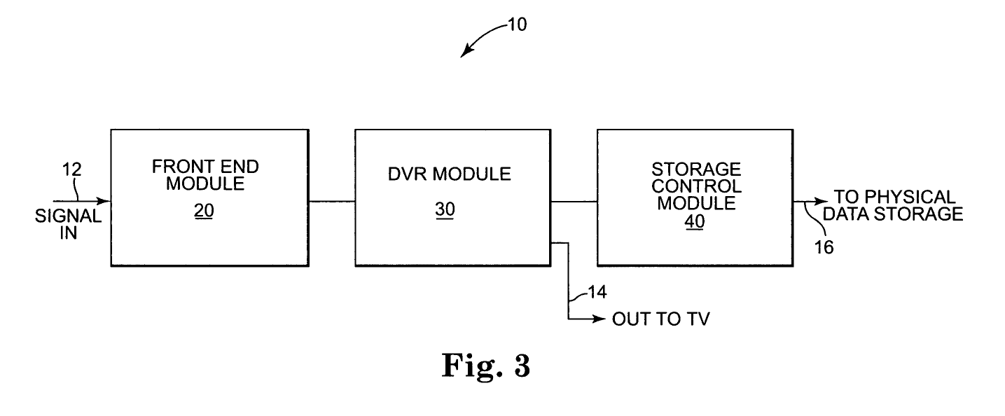

Video system 10 may be conceptually illustrated as a block diagram such as that shown in FIG. 3. FIG. 3 is a block diagram illustrating an example embodiment of the video system 10. Video system 10 includes one hardware board integrally housing a front end module 20, a DVR module 30 and a storage control module 40. Video module 10 is connectable to a mass storage device 100, such as a hard disk assembly or other mass storage device.

Audio and/or video signals (hereinafter referred to generally as “video signals”) are received over line 12 and live or recorded television programming or other video content (hereinafter referred to generally as “video content”) to be displayed is delivered along line 14 to an associated display device such as an analog or digital television or computer monitor. Video content destined for storage is delivered along line 16 to physical data storage, such as a magnetic hard disk drive or other type of mass storage media such as optical disk, magneto-optical disk, solid state memory or video RAM. Recorded material to be played back is also received from the physical data storage along line 16.

The incoming video signals may be any type of video signals, including analog, digital, satellite or cable television signals. The video signals may also include video information downloaded from a computer network, such as the Internet.

In the case of television signals, the source of the incoming video signal may take any of several forms, including conventional network broadcasts, satellite or cable transmission, whether in analog, digital or digitally compressed form. Depending upon the geographic location and market, television video signals coming into front end module 20 may take any of a number of analog or digital (or both) formats. Conventional analog television signals include, for example, National Television System Committee (NTSC), Phase Alternating Line (PAL) or Sequential Couleur Avec Memoire (SECAM) formats. Digital television may be received either via terrestrial broadcast digital television signals (DVB-T or ATSC) or via satellite (DVB-S) or digital cable (DVB-C) systems. Digital television signals may be either encrypted or non-encrypted.

Front end module 20 extracts selected video content from the incoming video signals. As such, front end module 20 includes circuitry that receives the incoming video signals and, in some embodiments, may include at least one tuner that tunes into a particular television channel to be displayed and/or recorded. In the case of conventional analog video signals, for example, front end module 20 includes circuitry that tunes into a particular frequency (i.e., television program) and digitizes and compresses the signal into a MPEG-2 or other digital format. In the case of digital television such as antenna, satellite, or cable, there is no encoding necessary in the DVR, as the satellite signal is already a digitally encoded MPEG stream. In that case, front end module 20 performs a relatively straightforward capture of the received digital data, feeds it to DVR module 30 which then sends the digital data stream to be stored directly to the mass storage device. In the case of digitized video content downloaded from the internet or other source, front end module includes the appropriate interfaces for receiving the downloaded video content (such as cable modem, Ethernet and/or wireless modem interfaces) and outputs the video content to a data bus.

DVR module 30 controls the storage, retrieval and display of the selected video content. To that end, DVR module 30 receives the selected video content from front end module 20 and outputs, on line 14, a conventional analog video signal for display on a standard TV display or a digital signal in the case of digital television. Additionally, if the user is watching TV in real time, DVR module 30 also transmits the selected video content (i.e., the selected television program) for storage in a mass storage device such as a hard disk drive assembly (not shown) via storage control module 40.

DVR module 30 also includes a receiver for receiving externally generated user inputs or commands from other devices. These user inputs could be provided, for example, via buttons or keys located on the exterior of the DVR housing or a via handheld remote control device. A microprocessor within DVR module 30 receives instructions from these user inputs and coordinates record and playback functions as necessary to effectuate particular commands.

Storage control module 40 manages the storage and retrieval of the selected video content to and from the mass storage device under control of the DVR module. Storage control module 40 generally includes all of the control electronics necessary to control the reading and writing of information to the mass storage device. The mass storage device may include a magnetic hard disk drive or other type of mass storage media such as optical disk, magneto-optical disk, solid state memory or video RAM, for example. In the case of a magnetic hard disk drive, for example, storage control module 40 includes a hard disk controller and associated read/write control circuitry, and is responsible for accurate rotation of the magnetic disks and coordination of recording (writing) and replay (reading) of information representative of video content to/from the disks. Reading and writing of stored video content may be carried out asynchronously to provide DVR functionality as described herein.

The components of video system 10 shown in FIG. 3 may be contained within any type of enclosure associated with video processing, such as a DVR box or other housing. Alternatively, the components of video system 10 may be integrated directly into an analog or digital television to provide DVR functionality in a TV. The components of video system 10 may also be integrated into any type of receiver, monitor, personal computer or other display device.

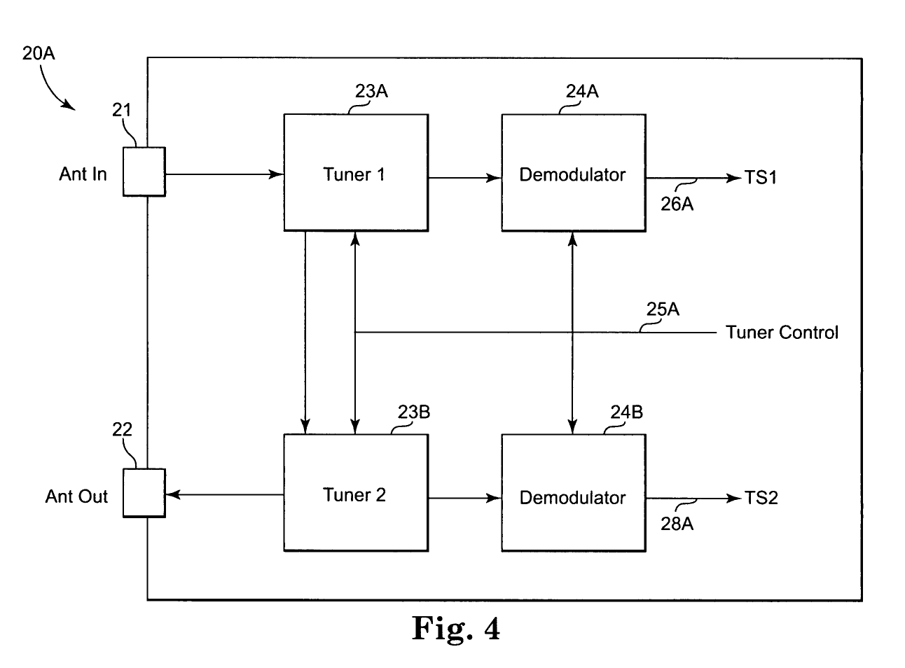

Because the different techniques for delivery of video content are broadcast over different frequencies (in the case of television video signals), or require different types of data connections (in the case of downloaded content over the internet), they require different sets of receiving circuitry at the front end. Four example embodiments of front end module 20 will therefore be described with respect to FIGS. 4, 5, 6 and 7. It shall be understood, however, that other embodiments directed at other systems for the delivery of video content or other embodiments directed at these same delivery systems may also be used without departing from the spirit and scope of the present invention. For example, the embodiments in FIGS. 4, 5, 6 and 7 may be combined in any combination into a single front end module.

FIG. 4 is a block diagram illustrating an example embodiment of a front end module 20A designed for standard definition digital television using standard terrestrial for broadcast transmission, using either the DVB-T or ATSC standards. The television signal arrives via a physical cable from an antenna such as is typically located on the roof of a building and is fed to front end module 20A via Ant In connector 21. As shown in FIG. 4, front end module 20A includes at least two terrestrial tuners, terrestrial tuner 1 23A and terrestrial tuner 2 23B, to provide for display of one program while recording another or the simultaneous recording of two different programs. The use of multiple tuners also allows for special effects such as picture in a picture. Terrestrial tuner 1 23A receives the incoming signal and passes it to terrestrial tuner 2 23B. Each of terrestrial tuners 23 is tuned independently via tuner control line 25A. Terrestrial tuner 2 23B may also pass the incoming signal back out of video system 10 via Ant Out connector 22 so that the signal may be fed to some other device if desired. It shall be understood that although the front end module 20A shown in FIG. 4 includes two terrestrial tuners, front end module 20A could also include more tuners if desired to provide further flexibility in program viewing and recording. In another embodiment, front end module 20A could include only a single tuner, for cost savings, but such an embodiment would not allow simultaneous tuning to two separate channels.

Front end module 20A also includes two terrestrial demodulators 24A and 24B, each associated with one of terrestrial tuners 23A and 23B, respectively. Terrestrial tuners 23A and 23B output the selected part of the high frequency incoming digital signal as determined by tuner control 25A to terrestrial demodulators 24A and 24B. Terrestrial demodulators 24A and 24B then separate the lower frequency digital content from the higher frequency carrier and output the digital video signals TS1 and TS2 along lines 26A and 28A, respectively.

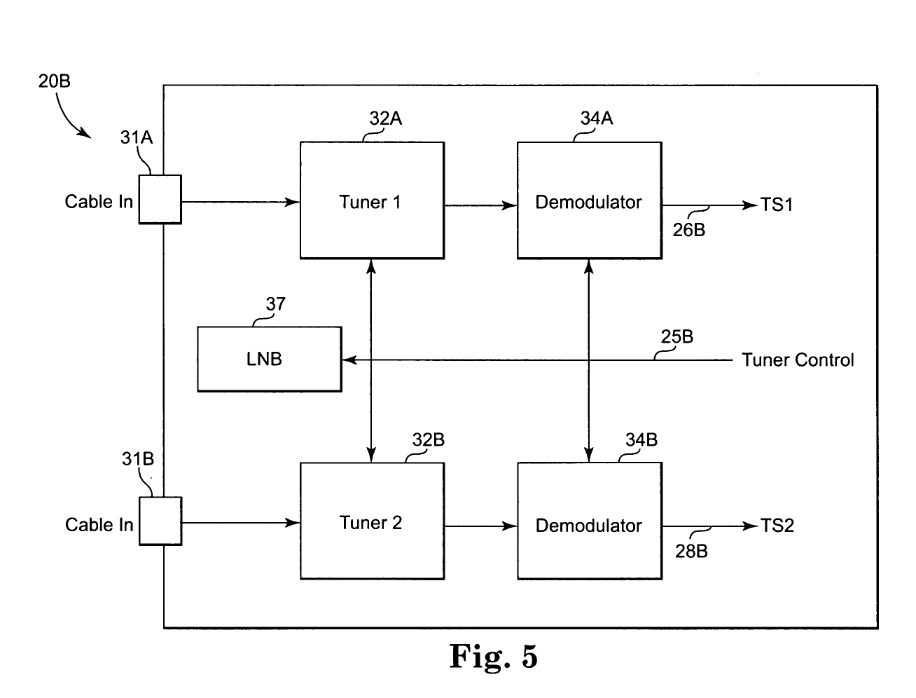

FIG. 5 is a block diagram illustrating another example embodiment of a front end module 20B designed for satellite television delivery system, such as DISH Network or DIRECTV®. Like the embodiment shown and described above with respect to FIG. 4, front end module 20B includes at least two tuners 32A and 32B to provide for display of one program while recording another or the simultaneous recording of two different programs. In a multiple tuner satellite television delivery system multiple physical cables, corresponding to the number of tuners in the system, run from the satellite receiver down to the DVR box. These cables deliver the incoming satellite signals to satellite tuners 32A and 32B via connectors Cable In 31A and 31B, respectively. Each of satellite tuners 32 is tuned independently via tuner control line 25B. As described above, satellite tuners 32A and 32B receive the selected part of the high frequency incoming digital signal as determined by tuner control 25B. Satellite demodulators 34A and 34B then separate the lower frequency digital content from the higher frequency carrier and output the digital video signals TS1 and TS2 along lines 26B and 28B, respectively. Front end module 20B also includes a low-noise block converter (LNB) 37, a piece of circuitry used in broadcast communications satellite reception.

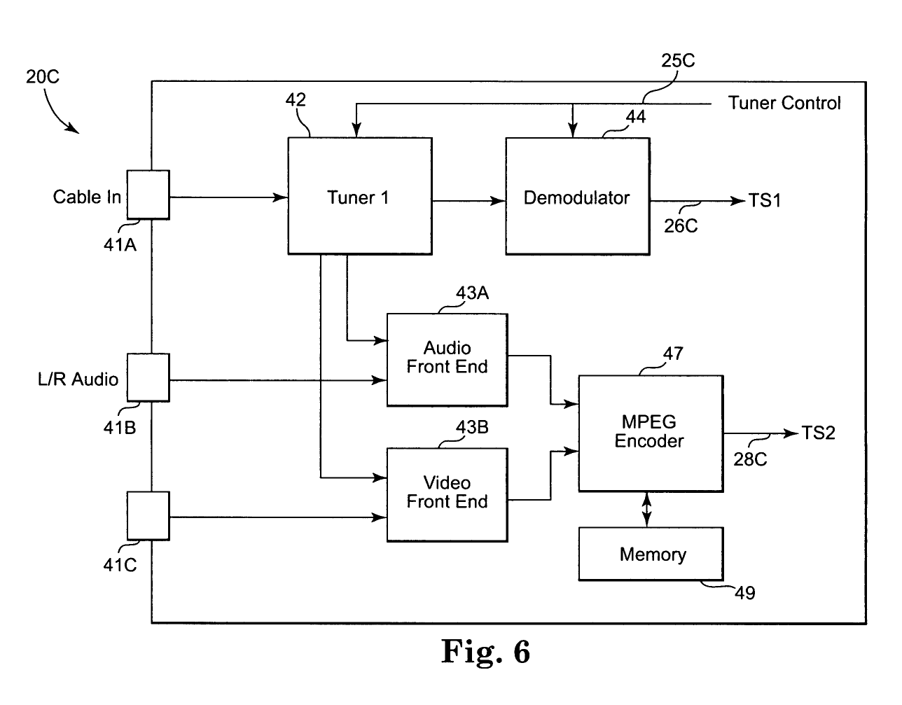

FIG. 6 is a block diagram illustrating another example embodiment of a front end module 20C designed for embedding in a television or other display device to provide DVR functionality in a TV. Front end module 20C is designed to handle both the North American ATSC (digital signal) and or NTSC (analog) television delivery standards. Incoming digital or analog content comes in from an antenna at Cable In connector 41A and is fed to cable tuner 1 42. In this embodiment, cable tuner 42 is a combination analog/digital tuner. Again, cable tuner 1 is tuned to a particular channel or frequency via tuner control 25C. In the case of a digital signal, the signal is fed through demodulator 44 which extracts the digital signal from the carrier frequency and outputs it as television signal TS1 on line 26C.

In the case of an analog signal, tuner 42 separates the audio and video portions of the incoming signal. Audio and video front end converters 43A and B converts each of them from analog to digital. The digitized audio and video signals are fed to an encoder 47, which takes the raw audio and raw video digital data and performs a compression algorithm to reduce the amount of data. In the embodiment of FIG. 6, encoder 47 encodes the signals into, for example, an MPEG-2 format, but encoder 47 may also use any appropriate standard or proprietary method of encoding data. A memory 49 is provided for use by encoder 47 during the encoding process. The encoded signal is then output as signal TS2 along line 28C. Left and Right Audio input 41B and composite Video input 41C allows a user to connect other external equipment (such a VCR) to video system 10.

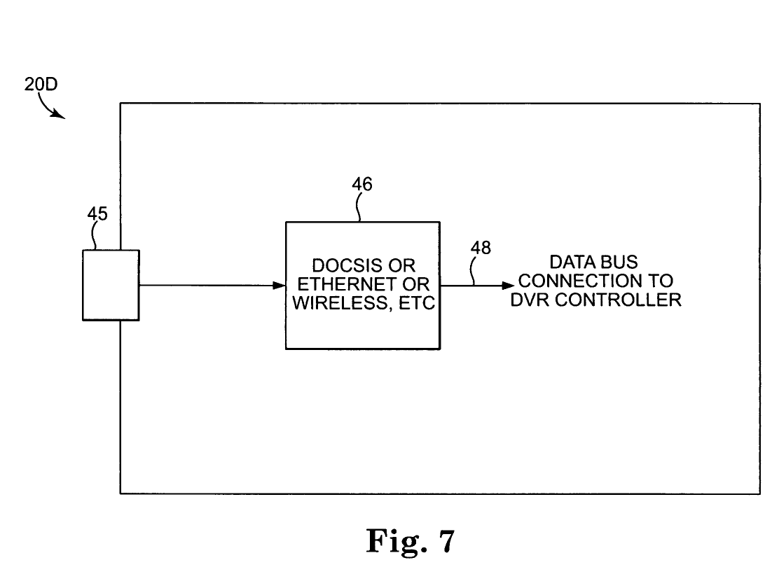

FIG. 7 is a block diagram illustrating another example embodiment of a front end module 20D. In particular, FIG. 7 is a block diagram illustrating an embodiment of a front end module 20D adapted for video content reception over the internet, for example, Internet Protocol Television (IPTV). Incoming digital content is received via connector 45, which may be one or a combination of several types such as a cable modem connector, Ethernet connection, wireless connection, etc. The incoming signal is fed to the appropriate DOCSIS (Data Over Cable Service Interface Specification) Ethernet, wireless, or other hardware that extracts the received video content. The extracted video content is then sent over a data bus 48 to the DVR module 30.

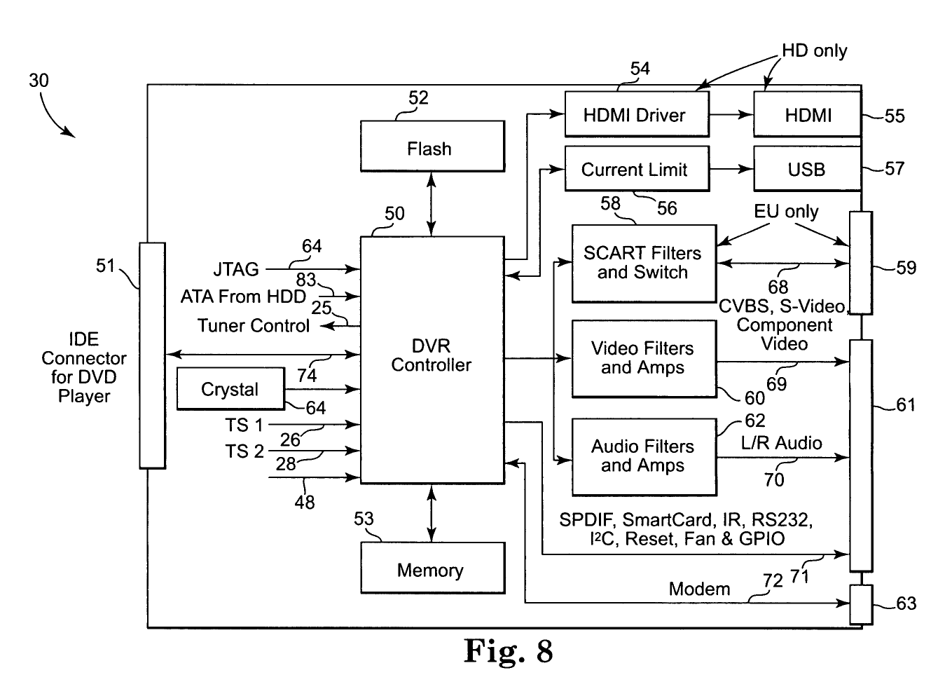

FIG. 8 is a block diagram illustrating an example embodiment of DVR module 30. DVR module 30 takes the incoming video signals TS1 and TS2 or downloaded video content and generates any of several types of television outputs (i.e., High Definition digital, composite video, s-video, component video, L/R Audio, etc.) from the digital (or digitized) video signals. DVR module 30 also provides for DVR functionality such as record, pause, rewind, fast forward, etc., and for automatic recordation of television programs as specified by the user.

To that end, DVR module 30 includes a DVR controller 50. DVR controller 50 controls various functions of video system 10 according to firmware stored in flash memory 52. The video signals TS1 and TS2 are fed into DVR controller 50 via lines 26 and 28 from front end module 20. Downloaded video content is fed into DVR controller via data bus 48. DVR controller 50 controls selection of the channel to be displayed or recorded via tuner control along line 25. An interface 83 connects DVR controller 50 to a HDD controller 80 (shown in FIG. 9). A standard IDE connector 51 (or other standard connector) allows a DVD player to be connected to DVR module 50 via line 74. A crystal 64 provides timing functions to DVR controller 50. A JTAG (Joint Test Action Group) input into DVR controller 50 along line 64 allows for JTAG testing and in-system flash programming of flash memory 52.

To provide the various types of television outputs, DVR controller 50 takes the incoming TS1 and TS2 signals and scales them up or down depending upon the application. DVR module 30 may include one or more output connectors depending upon the particular application or applications at which the video system 10 is directed. By having the necessary and flexible hardware and software interfaces, video system 10 allows quick design and manufacture of customized DVR solutions that meet local geographic and market requirements.

For example, DVR controller 50 may include a High-Definition Multi-media Interface (HDMI) 55. DVR controller 50 feeds the desired video signals to HDMI 55 via an associated HDMI driver 54. HDMI is an industry-supported, uncompressed, all-digital audio/video interface. HDMI provides an interface between any compatible digital audio/video source, such as a set-top box, DVD player, and A/V receiver and a compatible digital audio and/or video monitor, such as a digital television (DTV). HDMI supports standard, enhanced, or high-definition video, plus multi-channel digital audio on a single cable.

The video content may also be sent to or from a Universal Serial Bus (USB) connector 57. USB connector 57 (and associated current limit 56) allows a user to connect external devices such as PCs, laptop or other type of computing device to video system 10. The USB port may then be used to input or output a digital signal enabling high-quality transfer/recording of stored programs to a computer.

DVR controller 50 may also include a SCART switch 58 and its associated connector 59. SCART (from Syndicat des Constructeurs d'Appareils Radiorécepteurs et Téléviseurs) is a French-originated standard and associated connector for connecting audio and video equipment to television sets. The standard is used most often in Europe. The SCART connector's 21 pins carry two audio in and out channels, in and out video channels, RGB signals, ground and some additional control signals. Instead of multiple cables for left and right audio, component video etc., the SCART switch combines them into one common connector, avoiding the need for multiple cables.

For lower end applications, DVR controller 50 also modifies the incoming digital video signals and sends them to video filter and amps module 60, which generates the different types of analog video signals composite video baseband signal (CVBS), s-video and component video along line 69 and sends them to their associated output jacks within connector 61. DVR controller 50 also provides for output of a conventional Left/Right Audio jack along line 70 via audio filters and amps 62.

DVR controller 50 may also provide various other interfaces such as SPDIF (Sony/Philips Digital Interface, a standard audio transfer file format), SmartCard interface, infrared (IR) sensor, RS-232 serial port, Inter-Integrated Circuit Bus (I²C), Reset, Fan or programmable general purpose input/output (GPIO) along line 71 via connectors 61. DVR controller 50 may also input or output control information via line 72 to a modem connector 63.

DVR controller 50 may also provide user options with respect to selecting a particular compression algorithm or compression ratio, for example, to enable a viewer to select a lower-quality image to increase the available program recording time for a given amount of storage capacity. This quality vs. recording time compromise is analogous to that performed by users when selecting SP-mode vs. EP-mode recording options in a VCR. These user selectable options could affect various signal processing activities in DVR controller 50 such as compression ratio, spatial or temporal processing, frame-rate reduction and so forth.

In use, DVR controller 50 causes the desired digital television signal(s) to be stored on a mass storage device such as a magnetic hard disk drive. The digital video content is sent over a standard interface 83 (such as an ATA interface) to storage control module 40, which controls the reading and/or writing of video content to the hard disk.

FIG. 9 is a block diagram illustrating an example embodiment of storage control module 40. Storage control module 40 is operably connected to a physical data storage, which in this embodiment is shown as a HDA 100. Storage control module 40 controls the reading and/or writing of video content to and from HDA 100.

A hard disk drive controller 80 (hereinafter referred to as “HDD controller 80”) controls various operations of HDA 100 in accordance with firmware stored in memory 82A or flash 82B. A typical HDA 100 contains a motor that rotates one or more magnetic disks and one or more read/write heads positioned over desired tracks on the disks by a servo mechanism to read/write information to or from the disks. Storage control module 40 generally includes power control circuit 84 operably connected to HDD controller 80. Power control circuit 84 generates, among other things, voltages along line 92 that determine the rotational speed of the spindle motor, movement of the actuator for positioning of the read write heads, etc. under control of HDD controller 80.

HDD controller 80 also includes a read/write channel through which data is transmitted or received to/from HDA 100. Data is transferred between HDD controller 80 and HDA 100 via data bus 94. Interface 83, such as a standard ATA interface, connected to HDD controller 80 serves as a data interface between HDD controller 80 and DVR controller 50.

Connector 81 provides for connection to a JTAG interface, serial port, and power (both 5 and 12 Volt). JTAG is a standard industry interface and protocol that allows manipulation of a microprocessor, in this DVR controller 50 along line 64 (see FIG. 8), in a variety of ways for testing, downloading of firmware, testing of registers and flags, etc. A serial port allows same type of functionality as the JTAG port for the HDD controller 80.

Power control circuit 84 generates and distributes power to all of the electronic components and the HDA 100 of video system 10. Thus, video system 10 includes a single power control circuit 84 that generates, monitors and controls the power supplied to all of the components of video system 10, including the front end module 20, the DVR module 30 and the storage control module 40.

The −5 Volt and +3.3 Volt voltages output by power control circuit 84 are delivered to a preamp on the HDA 100 along line 85. The +3.3 volt signal is also shared between several components of storage control module 40, DVR module 30 and front end module 20.

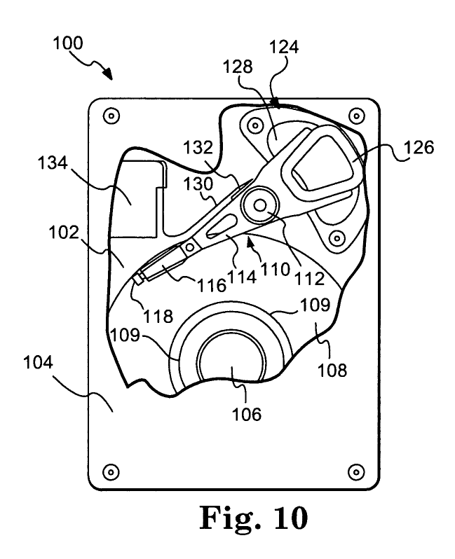

Power control circuit 84 also outputs a motor control signal and an actuator control signal along line 92. The motor control signal drives the motor that spins the magnetic storage disks on HDA 100. The actuator control signal goes to the actuator (reference numeral 126 in FIG. 10) of the hard disk drive. The actuator is a mechanical assembly that positions the read/write head assembly over the appropriate tracks. The control signals on line 92 thus control motors that spin the disks and move the actuator to the proper location.

Voltage controllers and filters 86 generates several voltages. The +2.5 Volt and +1.8 Volt signals are required by parts of disk drive and DVR and front end electronic digital components. The +5 Volt and +3.3 Volt analog voltages are associated with the audio/video outputs such as and left/right audio composite video, component video, S-video etc (see FIG. 8). The components that generate the audio/video outputs are analog components and are highly sensitive to noise. Thus, the +5 Volt and +3.3 Volt analog voltages generated for these components are filtered to eliminate noise generated by the voltages used by the digital components. The +5 Volt, +3.3 Volt, +1.8/1.0 Volt tuner voltages are also specially filtered because the tuners, which have both analog and digital components, are sensitive to the cleanliness of the voltages applied.

FIG. 10 is a top plan view of an example magnetic HDA 100 of the type which may be used in the present invention. It shall be understood that although the present invention is described with respect to a magnetic hard disk drive, other types of mass storage media may also be used, including, but not limited to, magnetic tape, optical disk, magneto-optical disk, solid state memory, video RAM, and others.

HDA 100 includes a base 102 to which various components of the HDA 100 are mounted. A top cover 104, shown partially cut away, cooperates with the base 102 to form an internal, sealed environment for the disk drive in a conventional manner. The components include a spindle motor 106 that rotates one or more disks 108 at a constant high speed. Information is written to and read from tracks on the disks 108 through the use of an actuator assembly 110, which rotates during a seek operation about a bearing shaft assembly 112 positioned adjacent the disks 108. The actuator assembly 110 includes a plurality of actuator arms 114 which extend towards the disks 108, with one or more flexures 116 extending from each of the actuator arms 114. Mounted at the distal end of each of the flexures 116 is a read/write head 118 which includes an air bearing slider (not shown) enabling the head 118 to fly in close proximity above the corresponding surface of the associated disk 108.

During a seek operation, the position of the read/write heads 118 over the disks 108 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well known Lorentz relationship. As the coil 126 moves, the actuator assembly 110 pivots about the bearing shaft assembly 112 and the heads 118 are caused to move across the surfaces of the disks 108.

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly terminates at a flex bracket 134 for communication through the base deck 102 to a disk drive printed circuit board (not shown) mounted to the bottom side of the disk drive 100.

As shown in FIG. 10, located on the surface of the disks 108 are a plurality of nominally circular, concentric tracks 109. Each track 109 preferably includes a number of servo fields that are periodically interspersed with user data fields along the track 109. The user data fields are used to store user data and the servo fields are used to store servo information used by a disk drive servo system to control the position of the read/write heads.

In operation of the HDA 100, power control circuit 84 receives servo position information from the tracks 109 via the read/write heads 118 and, in response thereto, provides a correction signal to the actuator coil 126 in order to position the heads 118 with respect to the disks 108. The read/write channel in storage control module 40 operates to write data to the tracks 109 in response to user data provided to the channel from the interface 83 by encoding and serializing the data and generating a write current utilized by the heads 118 to selectively magnetize portions of a selected track 109 on the disks 108. Correspondingly, data previously stored on a track 109 are retrieved by the read/write channel by reconstructing the data from the read signals generated by a head 118 as the head passes over the selected track 109 on the disk 108.

The digital storage of video signals by video module 10 provides a multimedia storage and display system that allows the user to view a video content such as television programs or downloaded video information with the option of instantly reviewing previous scenes within the program. Video system 10 also provides the user with the ability to store selected video content while simultaneously watching or reviewing another program and to view stored programs, as well as with various DVR trick play functions such as fast forward, fast reverse, slow forward, slow reverse, pause/resume, index, instant replay, etc. Video system 10 additionally supports the user ability to search video content according to categories. For example, viewers may search video content by title, actor, director, type or keyword. Services such as these also allow viewers to set up “wish lists” or “season passes” to automatically find and record desired video content.

Referring again to FIG. 8, DVR module 50 stores information relating to various points in a program in a memory 53. Memory 53 may also store various operational parameters, such as commands that are recognized by DVR controller 50. In this way, for example, when a “pause” command is received by DVR controller 50, memory 53 stores information relating to that point in the program, and when a “resume” command is received, playback automatically commences from that point, thereby outputting the program time shifted by the delay between the receipt of the two commands. When paused, the system may output a freeze frame and automatically keep track of correct program re-entry even upon receipt of multiple “pause” commands.

In the case of a “reverse” command, previously recorded points of the program may be rapidly accessed and displayed. That is, the program moves backwards while the reverse command is activated, for example, using an associated button on a remote control, until such time that the button is no longer depressed, at which time normal display of the program commences, but from a point in the program previous to real time. The system may also be capable of “rewind” in the sense that any previously recorded point of the program may be immediately accessed, with playback commencing therefrom, similar to a “rewind” function with a VCR.

If a time-shifted version of the stored video content is being viewed, a “fast forward” command may be entered, in which case playback is speeded up until deactivation of the command, at which time normal playback resumes, resulting in the output of the video signal exhibiting a reduced time shift, including a zero time shift in the event the operator “catches up” with the incoming video signal as it is being received in real time.

Optional operator controls may also enable the viewer to jump ahead in the stored video content, for example, to advance in increments of 30 seconds so as to avoid the viewing of commercial advertisements, as well as any other known DVR trick-play functions.

Memory 53 may also store downloaded television program information. The program information includes program guide information that is displayed to the subscriber in the format of a program guide including a listing of channels, programs for viewing on the channels, and times during which the programs are shown. The program information also includes channel information, such as the channel number and identification information, e.g., ESPN, Disney, Food Network, etc. The program information may additionally include category information that is indicative of different categories and channels included within each of the categories. For example, categories could include ALL, for all available channels; SPORTS, for sports and fitness channels; FAMILY, for channels that provide family oriented programming; FOOD, for channels that provide programs on cooking, food, and restaurants; and any other categories that could be of interest to the subscriber. A FAVORITES category could also be provided that permit the subscriber to program category and channel information. Furthermore, channels could be associated with more than one category, e.g., a primarily sports channel could be included in the categories of SPORTS, NEWS, FAMILY, and ENTERTAINMENT.

In use, video system 10 periodically downloads program information, such as programs and times by channel, into memory 53. It will be appreciated that the amount of this information that can be downloaded and the time between downloads may vary according to the subscriber's service and memory size. When, for instance, video system 10 provides access to hundreds or thousands of cable television channels, program information, including the programs, times, and perhaps even the categories for each channel, may be downloaded more often than when the system 100 provides fewer channels. Video system 10 may also receive updated program information as needed, such as when the cable channel lineup is changed or when the category offerings or channels included in the categories change. Video system 10 may also periodically download information for other types of video content such as movies, television programs or other video content available over the internet or from some other video content delivery method.

Video system 10 may provide for display of program information to the subscriber in a number of ways. For example, video system 10 may display a conventional program guide that provides automatic scrolling of channels in numerical sequence along with the program names, descriptions, and times associated with the channels. Alternatively, a static display can be provided, and the subscriber can provide commands, such as via a remote control, to scroll through the program information.

The video system 10 described herein has several advantages. For example, all of the components for the video system 10 are incorporated into a single circuit board, reducing the number and complexity of components needed to implement the video system and, as a result, the total cost of the video system. Reducing the number of components also improves the overall reliability of the video system. Further, the compact architecture results in a smaller overall size and thickness of the resulting video system. Integrating the DVR module and the HDD module into a single circuit board also reduces the need for communication between different circuit boards and delays associated with such inter-board communication. In other words, video system 10 provides for communication of information between the DVR module and the storage control module without forwarding the information between multiple circuit boards.

As another example, fabrication of video system 10 on a single circuit board allows video system 10 to take advantage of ground plane layer(s) located within the circuit board. The purpose of these ground plane layer(s) is to reduce grounding resistance and inductance as well as to provide a shield against EMI and RFI. Using a ground plane to connect all ground points on a circuit board helps to ensure that all circuit ground points are at the same potential. A ground plane also reduces the effect of radiated EMI on the performance of a circuit by reducing the electrical field strength in the vicinity of the ground plane. In this way, electrical noise, together with EMI and ESD performance, can be significantly improved by the use of a ground plane. This may significantly reduce or even eliminate the necessity of additional external shielding. In addition, the physical layout of the circuit board on which video system is manufactured may be designed such that the circuit board traces are as short as possible, which may further minimize EMI radiation.

Integration of front end module 20, DVR module 30 and storage control module 40 on a single circuit board also allows each of these components to share power supplies, memory buffers and other hardware components and eliminates unnecessary interconnects. For example, the various voltages supplied by voltage regulator 86 on storage control module 40 (see FIG. 9) may be shared among the various system components. For example, video system 10 includes a single power control circuit that monitors and controls the power supplied to all of the components of video system 10, including the front end module 20, the DVR module 30 and the storage control module 40. Thus, fabrication of video system 10 on a single circuit board reduces redundant repetition of certain circuit board components leading to an associated reduction in size, cost and complexity of the resulting video system 10.

Furthermore, integration of front end module 20, DVR module 30 and storage control module 40 on a single circuit board also allows a supplier to deliver video system 10 as a completely assembled and tested video controller. This may be of great advantage to DVR manufacturers, who would no longer need to go through the lengthy and costly design process required to combine the individual components into a workable DVR system.

As a result, video system 10 is a complete, tested hardware and software solution that integrates the features of a hard disk drive with DVR control functionality. By having the necessary hardware and software interfaces, it allows quick design and manufacture of customized DVR solutions that meet local geographic and market requirements.

Various embodiments of the invention have been described. These and other embodiments are within the scope of the following claims.

1. A digital video system comprising:
a digital video recorder (DVR) module that controls storage, retrieval and display of video content; and
a storage control module that manages the storage and retrieval of the video content to and from a mass storage device under control of the DVR module;
wherein the DVR module and the storage control module are integrated onto a single circuit board.

2. The video system of claim 1, wherein the mass storage device is a hard drive assembly.

3. The video system of claim 1, further including a front end module that extracts the video content from incoming video signals.

4. The video system of claim 3, wherein the video signals comprise at least one of conventional terrestrial analog broadcast, terrestrial digital, satellite, cable video signals or digital video content received via the internet.

5. The video system of claim 1, wherein the DVR module further provides DVR trick play functionality.

6. The video system of claim 5, wherein the DVR trick play functionality includes at least one of fast forward, fast reverse, slow forward, slow reverse, pause/resume and instant replay.

7. The video system of claim 1, wherein the DVR module and the hard disk module are connected on the single circuit board using a circuit board trace.

8. The video system of claim 1, wherein the DVR module further controls playback of the stored video content.

9. The video system of claim 1, wherein the DVR module further receives and responds to user commands relating to playback of the stored video content.

10. The video system of claim 1, further comprising at least one of a High-Definition Multi-media Interface (HDMI), a Universal Serial Bus connector, a SCART connector and a modem interface.

11. The video system of claim 1, further comprising at least one of composite video, s-video, component video and Left/Right audio outputs.

12. The video system of claim 1, further comprising at least one of SPDIF (Sony/Philips Digital Interface), a SmartCard interface, an infrared (IR) sensor, an RS-232 serial port, an Inter-Integrated Circuit Bus (I²C), Reset, Fan or programmable general purpose input/output (GPIO).

13. A digital video system comprising:
a digital video recorder (DVR) controller that controls storage, retrieval and display of video content;
a storage controller that manages the storage and retrieval of the video content to and from a mass storage device under control of the DVR controller; and
a single circuit board that interconnects the DVR controller and the storage controller.

14. The video system of claim 12, wherein the mass storage device is a hard drive assembly.

15. The video system of claim 12, wherein the mass storage device is one of an optical disk, a magneto-optical disk, a solid state memory or a video random access memory.

16. A digital video system comprising:
a digital video recorder (DVR) controller that controls storage, retrieval and display of selected video content;
a storage controller that manages the storage and retrieval of the selected video content to and from a mass storage device under control of the DVR module; and
a single power control circuit that generates, monitors and controls power supplied to the DVR controller and the storage controller.

17. The digital video system of claim 16, further including a single circuit board that interconnects the DVR controller, the storage controller and the single power control circuit.

18. A digital video system comprising:
a digital video recorder (DVR) controller that controls storage, retrieval and display of selected video content; and
a storage control controller that manages the storage and retrieval of the selected video content to and from a mass storage device under control of the DVR controller;
wherein information is communicated between the DVR controller and the storage controller without forwarding the information between multiple circuit boards.

19. The digital video system of claim 18, wherein the DVR controller and the storage controller are integrated onto a single circuit board.

20. A digital video system comprising:
a digital video recorder (DVR) controller that controls storage, retrieval and display of video content; and
a storage controller that manages the storage and retrieval of the video content to and from a mass storage device under control of the DVR module;
wherein the DVR controller and the storage controller are integrated onto a single circuit board.

21. The video system of claim 20, wherein the mass storage device is a hard drive assembly.

22. The video system of claim 20, further including a front end that extracts the video content from incoming video signals.

23. The video system of claim 22, wherein the video signals comprise at least one of conventional terrestrial analog broadcast, terrestrial digital, satellite, cable video signals or digital video content received via the internet.

24. The video system of claim 22 wherein the front end extracts the video content from the incoming video signals in response to user commands relating to selection of desired video content.

25. The video system of claim 20, wherein the DVR controller further controls playback of the stored video content.

26. The video system of claim 20, wherein the DVR controller further receives and responds to user commands relating to storage and playback of the video content.

27. The video system of claim 20, further comprising a single power control circuit that generates, monitors and controls power supplied to the DVR controller and the storage controller.

28. A digital video system comprising:
a digital video recorder (DVR) controller that controls storage, retrieval and display of video content; and
a storage controller that manages the storage and retrieval of the video content to and from a mass storage device under control of the DVR module;
wherein the DVR controller and the storage controller are integrated onto a single circuit board and are not connected by an external cable.

29. The video system of claim 28, wherein the mass storage device is a hard drive assembly.

30. A video system comprising one hardware board integrally housing a digital video recorder (DVR) module, a storage control module and a front end module.
